(19) United States
(12) Patent Application Publication
(10) Pub. No.: US 2026/0063880 A1
(43) Pub. Date: Mar. 5, 2026

(54) PLASTIC OPTICAL FOLDING ELEMENT, IMAGING LENS MODULE AND ELECTRONIC DEVICE

(71) Applicant: LARGAN PRECISION CO., LTD., Taichung City (TW)

(72) Inventors: Shih-Jung HSU, Taichung City (TW); Chen-Wei FAN, Taichung City (TW)

(21) Appl. No.: 19/304,678

(22) Filed: Aug. 20, 2025

Related U.S. Application Data
(60) Provisional application No. 63/687,363, filed on Aug. 27, 2024.

(51) Int. Cl. G02B 17/08

(52) U.S. Cl. CPC G02B 17/08

(57) ABSTRACT

A plastic optical folding element includes an incident surface, at least one reflection surface, an exiting surface and a reflection film. A light enters the plastic optical folding element through the incident surface. The reflection surface is for changing a traveling direction of the light. The light leaves the plastic optical folding element from the exiting surface. A reflection film is disposed on the reflection surface, a bottom of the reflection film is physically contacted with the reflection surface, a top of the reflection film is disposed relative to the bottom. The reflection film includes, in order from the bottom to the top which is away from the reflection surface, a first multilayer film, a first connecting layer, a first Ag layer and a blocking layer.

### RELATED APPLICATIONS

This application claims priority to Provisional Application Ser. No. 63/687,363, filed Aug. 27, 2024, which is herein incorporated by reference.

### BACKGROUND

### Technical Field

The present disclosure relates to a plastic optical folding element and an imaging lens module. More particularly, the present disclosure relates to an plastic optical folding element and an imaging lens module applicable to portable electronic devices.

### Description of Related Art

In recent years, portable electronic devices have developed rapidly. For example, intelligent electronic devices and tablets have been filled in the lives of modern people, and imaging lens assemblies mounted on portable electronic devices have also prospered. However, as technology advances, the quality requirements of the imaging lens assembly are becoming higher and higher. Therefore, an imaging lens assembly, which can enhance the image quality, needs to be developed.

### SUMMARY

According to one aspect of the present disclosure, a plastic optical folding element includes an incident surface, at least one reflection surface, an exiting surface and a reflection film. A light enters the plastic optical folding element through the incident surface. The reflection surface is for changing a traveling direction of the light. The light leaves the plastic optical folding element from the exiting surface. A reflection film is disposed on the reflection surface, a bottom of the reflection film physically contacted with the reflection surface, a top of the reflection film disposed relative to the bottom. The reflection film includes, in order from the bottom to the top which is away from the reflection surface, a first multilayer film, a first connecting layer, a first Ag layer, a blocking layer and a second multilayer film. The first multilayer film includes at least one first low reflectance layer and at least one first high reflectance layer. A reflectance of the first high reflectance layer is higher than a reflectance of the first low reflectance layer, and the first high reflectance layer and the first low reflectance layer are stacked alternatively. The first connecting layer includes Aluminium oxide. The first Ag layer includes Argentum. The blocking layer includes at least one of Nickel, Titanium, Vanadium, Chromium, Nickel oxide, Titanium oxide, Vanadium oxide and Chromium oxide. The second multilayer film includes at least one second low reflectance layer and at least one second high reflectance layer. A reflectance of the second high reflectance layer is higher than a reflectance of the second low reflectance layer, and the second high reflectance layer and the second low reflectance layer are stacked alternatively. When a thickness of the first multilayer film is Dmf1, a thickness of the blocking layer is Db, and a distance between the first Ag layer and the bottom is Hag1, the following conditions are satisfied: 70 nm<Dmf1<420 nm; 20 nm<Db<180 nm; and 90 nm<Hag1<550 nm.

According to one aspect of the present disclosure, a plastic optical folding element includes an incident surface, at least one reflection surface, an exiting surface and a reflection film. A light enters the plastic optical folding element through the incident surface. The reflection surface is for changing a traveling direction of the light. The light leaves the plastic optical folding element from the exiting surface. A reflection film is disposed on the reflection surface, a bottom of the reflection film is physically contacted with the reflection surface, a top of the reflection film is disposed relative to the bottom. The reflection film includes, in order from the bottom to the top which is away from the reflection surface, a first multilayer film, a first connecting layer, a first Ag layer and a blocking layer. The first multilayer film includes at least one first low reflectance layer and at least one first high reflectance layer. A reflectance of the first high reflectance layer is higher than a reflectance of the first low reflectance layer, and the first high reflectance layer and the first low reflectance layer are stacked alternatively. The first connecting layer includes Aluminium oxide. The first Ag layer includes Argentum. The blocking layer includes at least one of Nickel, Titanium, Vanadium, Chromium, Nickel oxide, Titanium oxide, Vanadium oxide and Chromium oxide. When a thickness of the first multilayer film is Dmf1, a thickness of the blocking layer is Db, and a distance between the first Ag layer and the bottom is Hag1, the following conditions are satisfied: 0.1<Db/Dmf1<0.9; 70 nm<Dmf1<420 nm; and 90 nm<Hag1<550 nm.

According to one aspect of the present disclosure, an imaging lens module includes the plastic optical folding element of the foregoing aspect.

According to one aspect of the present disclosure, an electronic device includes the imaging lens module of the foregoing aspect.

### BRIEF DESCRIPTION OF THE DRAWINGS

The present disclosure can be more fully understood by reading the following detailed description of the embodiment, with reference made to the accompanying drawings as follows:

FIG. 1A is a schematic view of an imaging lens module according to the 1st example of the 1st embodiment of the present disclosure.

FIG. 1B is a side view of the plastic optical folding element according to the 1st example of the 1st embodiment of FIG. 1A.

FIG. 1C is a three-dimensional view of the plastic optical folding element of FIG. 1B.

FIG. 1D is another three-dimensional view of the plastic optical folding element of FIG. 1B.

FIG. 1E is a schematic view of the reflection film of FIG. 1B.

FIG. 1F is a schematic view of the first multilayer film of FIG. 1E.

FIG. 1G is a schematic view of the second multilayer film of FIG. 1E.

FIG. 1H shows the reflectance of each of the first side and the second side of the reflection film.

FIG. 1I is a three-dimensional view of the plastic optical folding element according to the 2nd example of the 1st embodiment of the present disclosure.

FIG. 2A is a schematic view of an imaging lens module according to the 1st example of the 2nd embodiment of the present disclosure.

FIG. 2B is a side view of the plastic optical folding element according to the 1st example of the 2nd embodiment of FIG. 2A.

FIG. 2C is a three-dimensional view of the plastic optical folding element of FIG. 2B.

FIG. 2D is a schematic view of the reflection film of FIG. 2B.

FIG. 2E is a schematic view of the first multilayer film of FIG. 2D.

FIG. 2F is a schematic view of the second multilayer film of FIG. 2D.

FIG. 2G shows the reflectance of each of the first side and the second side of the reflection film.

FIG. 3A is a schematic view of an imaging lens module according to the 1st example of the 3rd embodiment of the present disclosure.

FIG. 3B is a side view of the plastic optical folding element according to the 1st example of the 3rd embodiment of FIG. 3A.

FIG. 3C is a three-dimensional view of the plastic optical folding element of FIG. 3B.

FIG. 3D is a schematic view of the reflection film of FIG. 3B.

FIG. 3E is a schematic view of the first multilayer film of FIG. 3D.

FIG. 3F is a schematic view of the second multilayer film of FIG. 3D.

FIG. 4A is a schematic view of an electronic device according to the 4th embodiment of the present disclosure.

FIG. 4B is another schematic view of the electronic device according to the 4th embodiment of FIG. 4A.

FIG. 4C is a schematic view of an image captured via the electronic device according to the 4th embodiment of FIG. 4A.

FIG. 4D is another schematic view of the image captured via the electronic device according to the 4th embodiment of FIG. 4A.

FIG. 4E is the other schematic view of the image captured via the electronic device according to the 4th embodiment of FIG. 4A.

FIG. 5 is a schematic view of an electronic device according to the 5th embodiment of the present disclosure.

### DETAILED DESCRIPTION

The present disclosure provides a plastic optical folding element, which includes an incident surface, at least one reflection surface, an exiting surface and a reflection film. A light enters the plastic optical folding element through the incident surface. The reflection surface is for changing a traveling direction of the light. The light leaves the plastic optical folding element from the exiting surface. A reflection film is disposed on the reflection surface, a bottom of the reflection film physically contacted with the reflection surface, a top of the reflection film disposed relative to the bottom. The reflection film includes, in order from the bottom to the top which is away from the reflection surface, a first multilayer film, a first connecting layer, a first Ag layer, a blocking layer and a second multilayer film. The first multilayer film includes at least one first low reflectance layer and at least one first high reflectance layer. A reflectance of the first high reflectance layer is higher than a reflectance of the first low reflectance layer, and the first high reflectance layer and the first low reflectance layer are stacked alternatively. The first connecting layer includes Aluminium oxide. The first Ag layer includes Argentum. The blocking layer includes at least one of Nickel, Titanium, Vanadium, Chromium, Nickel oxide, Titanium oxide, Vanadium oxide and Chromium oxide. The second multilayer film includes at least one second low reflectance layer and at least one second high reflectance layer. A reflectance of the second high reflectance layer is higher than a reflectance of the second low reflectance layer, and the second high reflectance layer and the second low reflectance layer are stacked alternatively. When a thickness of the first multilayer film is Dmf1, a thickness of the blocking layer is Db, and a distance between the first Ag layer and the bottom is Hag1, the following conditions are satisfied: 70 nm<Dmf1<420 nm; 20 nm<Db<180 nm; and 90 nm<Hag1<550 nm. Therefore, it is favorable for increasing the transmittance of light and favorable for adjusting the spectrum of reflected light by the first multilayer film; the first connecting layer is favorable for enhancing the connecting stability of the first Ag layer; the second multilayer film is favorable for protecting the blocking layer and further protecting the first Ag layer. When the thickness of the blocking layer satisfies the foregoing condition, which is favorable for protecting the first Ag layer from being oxidized or damaged by external force. It is favorable for preventing the first Ag layer from being oxidized under the environment with high temperature and high humidity by increasing the distance between the first Ag layer and the reflection surface.

Specifically, the blocking layer can be alloy of at least two metals, such as nickel-titanium alloy, but the present disclosure will not be limited thereto. Further, according to the present disclosure, the main material of each layer represents that the main material account for more than 50% of the entire material.

The reflection film can further include a second Ag layer and a second connecting layer. The second Ag layer includes Argentum, and is located between the blocking layer and the second multilayer film. The second Ag layer is farther from the at least one reflection surface than the blocking layer from the at least one reflection surface, and is physically contacted with the blocking layer. The second connecting layer includes Aluminium oxide, wherein the second connecting layer is farther from the at least one reflection surface than the second Ag layer from the at least one reflection surface, and is physically contacted with the second Ag layer. Therefore, the two sides of the reflection film can provide reflection function by adding the second Ag layer, which is favorable for enhancing the efficiency of the optical quality inspection of the reflection film.

A layer number of the reflection film and a layer material of the reflection film can be symmetrically arranged with the blocking layer as a center. Therefore, it is favorable for the efficiency of the optical quality inspection of the reflection film by aligning the optical functions of the two sides of the reflection film.

At least one of the incident surface, the exiting surface and the at least one reflection surface can have a curvature. Since the light reflection direction is not easy to be controlled and the optical quality inspection of the reflection film is not easy to be achieved when the reflection film has curvature, thus, it is favorable for quickly checking of the optical quality of the reflection film by arranging two-side reflection function when the surface of the plastic optical folding element with curvature. Further, the incident surface and the exiting surface can be further disposed with anti-reflective films.

A number of the at least one reflection surface can be at least two. Since light may be reflected multiple times inside a plastic optical folding element having a plurality of reflection surfaces, and detection instruments cannot inspect the quality of reflected light inside the plastic optical folding element, the reflection film with two-side reflection function is favorable for inspecting the optical quality of the reflective film from the outside of the plastic optical folding element.

When a distance between the second Ag layer and the top is Hag2, the following condition is satisfied: 60 nm<Hag2<480 nm. Therefore, it is favorable for preventing the second Ag layer from being oxidized.

When the distance between the first Ag layer and the bottom is Hag1, the following condition is satisfied: 180 nm<Hag1<460 nm. Therefore, it is favorable for preventing the first Ag layer from being oxidized.

When the thickness of the blocking layer is Db, the following condition is satisfied: 35 nm<Db<120 nm. Therefore, it is favorable for protecting the Ag layer.

When an average reflectance measured from the bottom of the reflection film reflective to a wavelength from 400 nm to 1000 nm is R1, the following condition is satisfied: 85%<R1<100%. Therefore, it is favorable for enhancing the image quality of the imaging lens module.

When an average reflectance measured from the top of the reflection film reflective to a wavelength from 400 nm to 1000 nm is R2, the following condition is satisfied: 95%<R2<100%. Therefore, it is favorable for inspecting the quality of the reflection film.

A main material of the blocking layer can be Nickel. It is favorable for preventing the first Ag layer being oxidized due to good adhesion between Nickel and Argentum.

The plastic optical folding element can further include a plurality of connecting surfaces connected to the incident surface, the exiting surface and the reflection surface, wherein there is a step structure between the reflection surface and one of the connecting surfaces adjacent thereto for forming a height difference between the reflection surface and the connecting surface. When the height difference is Hs, the following condition is satisfied: 0.005 mm≤Hs≤0.22 mm. Therefore, it is favorable for controlling the surface accuracy of the mold, and is favorable for performing Automated Optical Inspection (AOI). In detail, the gate trace can be further disposed on the connecting surface, which is favorable for avoiding stray light. Further, the light absorbing material can be disposed on the connecting surface, which can reduce the light reflection. Moreover, the step structure can also be arranged on the incident surface or the exiting surface, and the present disclosure will not be limited to the embodiment or the example herein.

The present disclosure provides a plastic optical folding element, which includes an incident surface, at least one reflection surface, an exiting surface and a reflection film. A light enters the plastic optical folding element through the incident surface. The reflection surface is for changing a traveling direction of the light. The light leaves the plastic optical folding element from the exiting surface. A reflection film is disposed on the reflection surface, a bottom of the reflection film is physically contacted with the reflection surface, a top of the reflection film is disposed relative to the bottom. The reflection film includes, in order from the bottom to the top which is away from the reflection surface, a first multilayer film, a first connecting layer, a first Ag layer and a blocking layer. The first multilayer film includes at least one first low reflectance layer and at least one first high reflectance layer. A reflectance of the first high reflectance layer is higher than a reflectance of the first low reflectance layer, and the first high reflectance layer and the first low reflectance layer are stacked alternatively. The first connecting layer includes Aluminium oxide. The first Ag layer includes Argentum. The blocking layer includes at least one of Nickel, Titanium, Vanadium, Chromium, Nickel oxide, Titanium oxide, Vanadium oxide and Chromium oxide. When a thickness of the first multilayer film is Dmf1, a thickness of the blocking layer is Db, and a distance between the first Ag layer and the bottom is Hag1, the following conditions are satisfied: 0.1<Db/Dmf1<0.9; 70 nm<Dmf1<420 nm; and 90 nm<Hag1<550 nm. Therefore, it is favorable for increasing the transmittance of light and favorable for adjusting the spectrum of reflected light by the first multilayer film; the first connecting layer is favorable for enhancing the connecting stability of the first Ag layer. When the thickness of the blocking layer satisfies the foregoing condition, which is favorable for protecting the first Ag layer from being oxidized or damaged by external force. It is favorable for preventing the first Ag layer from being oxidized under the environment with high temperature and high humidity by increasing the distance between the first Ag layer and the reflection surface.

Specifically, the blocking layer can be alloy of at least two metals, such as nickel-titanium alloy, but the present disclosure will not be limited thereto. Further, according to the present disclosure, the main material of each layer represents that the main material account for more than 50% of the entire material.

The reflection film can further include a second Ag layer including Argentum, wherein the second Ag layer is farther from the at least one reflection surface than the blocking layer from the at least one reflection surface, and is physically contacted with the blocking layer. Therefore, the two sides of the reflection film can provide reflection function by adding the second Ag layer, which is favorable for enhancing the efficiency of the optical quality inspection of the reflection film.

At least one of the incident surface, the exiting surface and the at least one reflection surface can have a curvature. Since the light reflection direction is not easy to be controlled and the optical quality inspection of the reflection film is not easy to be achieved when the reflection film has curvature, thus, it is favorable for quickly checking of the optical quality of the reflection film by arranging two-side reflection function when the surface of the plastic optical folding element with curvature. Further, the incident surface and the exiting surface can be further disposed with anti-reflective films.

A number of the at least one reflection surface can be at least two. Since light may be reflected multiple times inside a plastic optical folding element having a plurality of reflection surfaces, and detection instruments cannot inspect the quality of reflected light inside the plastic optical folding element, the reflection film with two-side reflection function is favorable for inspecting the optical quality of the reflective film from the outside of the plastic optical folding element.

When the distance between the first Ag layer and the bottom is Hag1, the following condition is satisfied: 180 nm<Hag1<460 nm. Therefore, it is favorable for preventing the first Ag layer from being oxidized.

When the thickness of the blocking layer is Db, the following condition is satisfied: 35 nm<Db<120 nm. Therefore, it is favorable for protecting the Ag layer.

When the thickness of the first multilayer film is Dmf1, and the thickness of the blocking layer is Db, the following condition is satisfied: 0.1<Db/Dmf1<0.4. Therefore, both of the two sides of the first Ag layer can be protected.

When an average reflectance measured from the bottom of the reflection film reflective to a wavelength from 400 nm to 1000 nm is R1, the following condition is satisfied: 85%<R1<100%. Therefore, it is favorable for enhancing the image quality of the imaging lens module.

When an average reflectance measured from the top of the reflection film reflective to a wavelength from 400 nm to 1000 nm is R2, the following condition is satisfied: 95%<R2<100%. Therefore, it is favorable for inspecting the quality of the reflection film.

A main material of the blocking layer can be Nickel. It is favorable for preventing the first Ag layer being oxidized due to good adhesion between Nickel and Argentum.

The plastic optical folding element can further include a plurality of connecting surfaces connected to the incident surface, the exiting surface and the reflection surface, wherein there is a step structure between the reflection surface and one of the connecting surfaces adjacent thereto for forming a height difference between the reflection surface and the connecting surface. When the height difference is Hs, the following condition is satisfied: 0.005 mm≤Hs≤0.22 mm. Therefore, it is favorable for controlling the surface accuracy of the mold, and is favorable for performing Automated Optical Inspection (AOI). In detail, the gate trace can be further disposed on the connecting surface, which is favorable for avoiding stray light. Further, the light absorbing material can be disposed on the connecting surface, which can reduce the light reflection. Moreover, the step structure can also be arranged on the incident surface or the exiting surface, and the present disclosure will not be limited to the embodiment or the example herein.

The present disclosure provides an imaging lens module, which includes the aforementioned plastic optical folding element.

The present disclosure provides an electronic device, which includes the aforementioned imaging lens module.

### 1st Embodiment

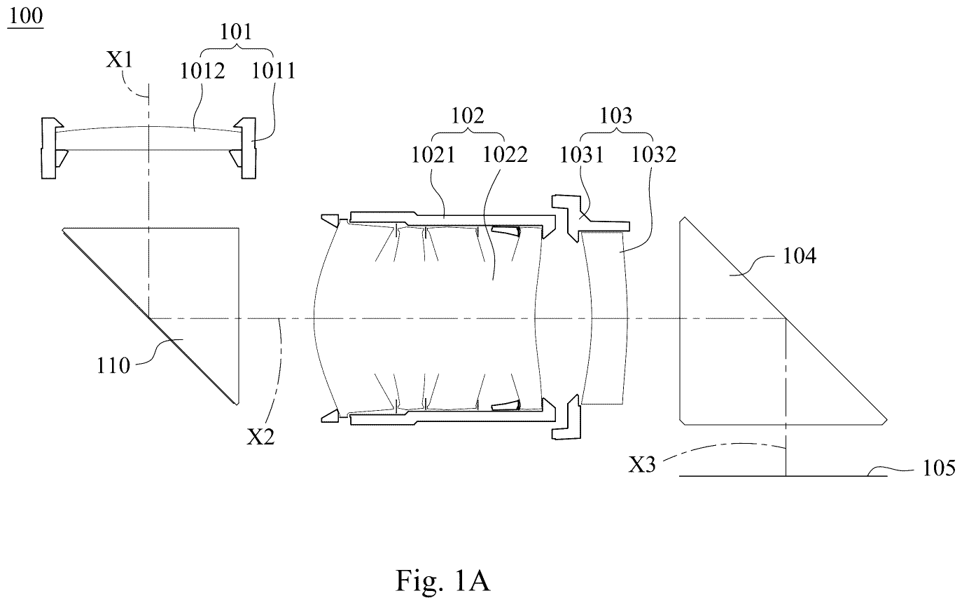

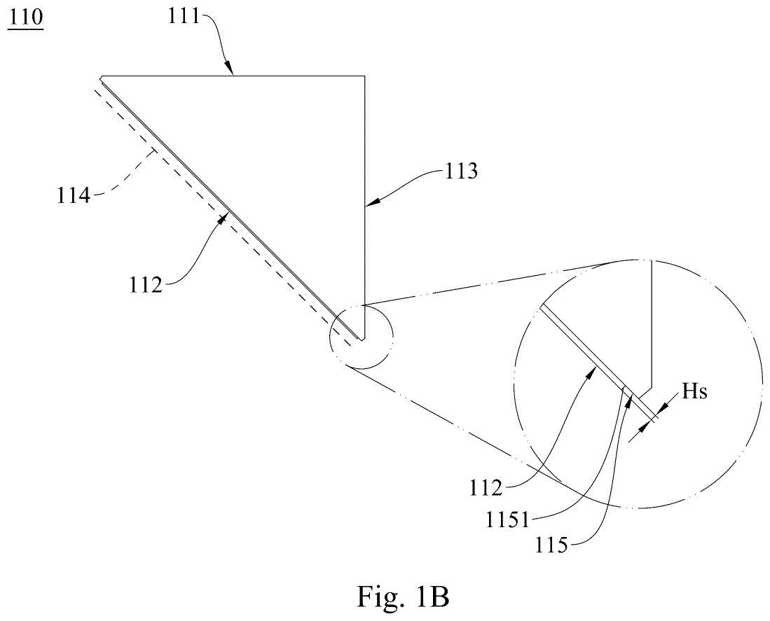

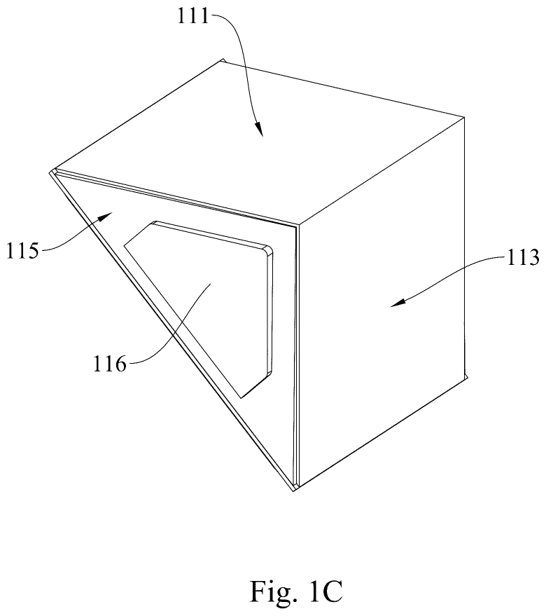

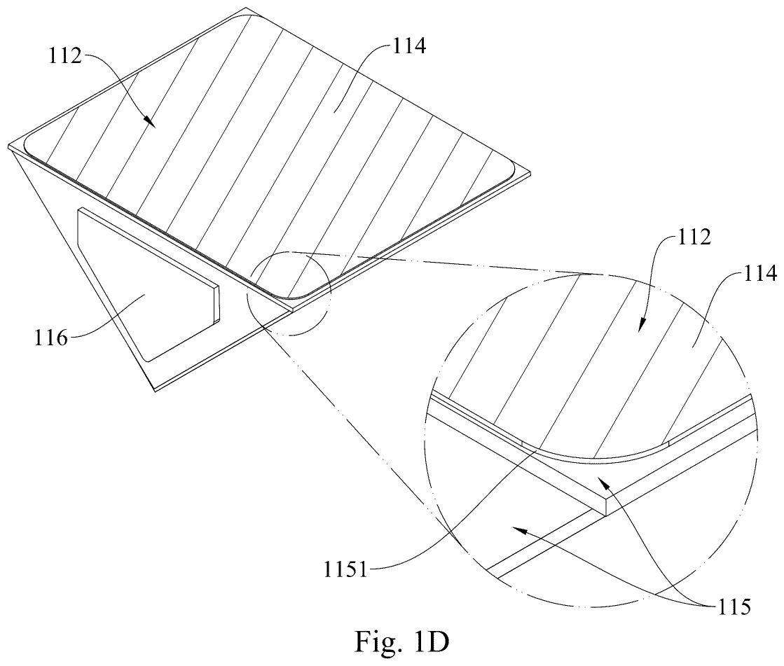

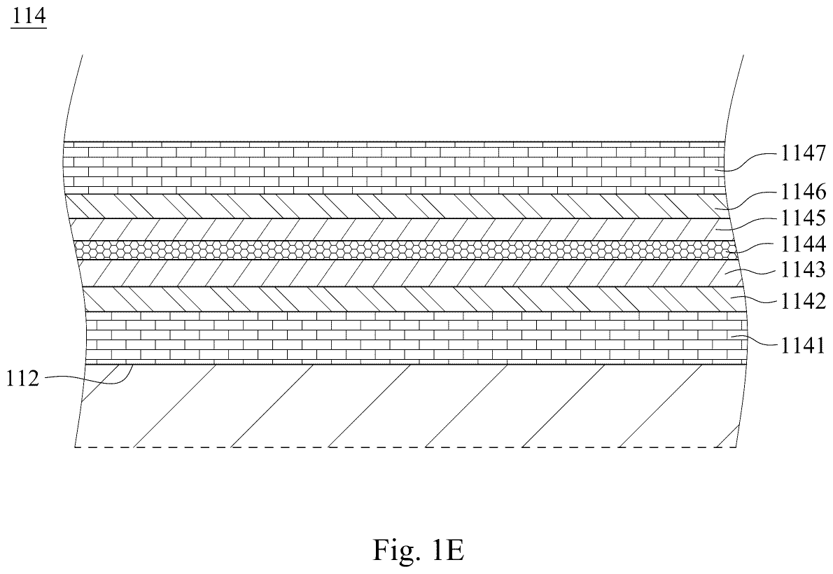

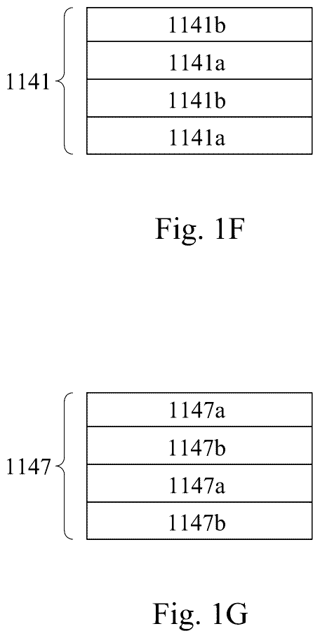

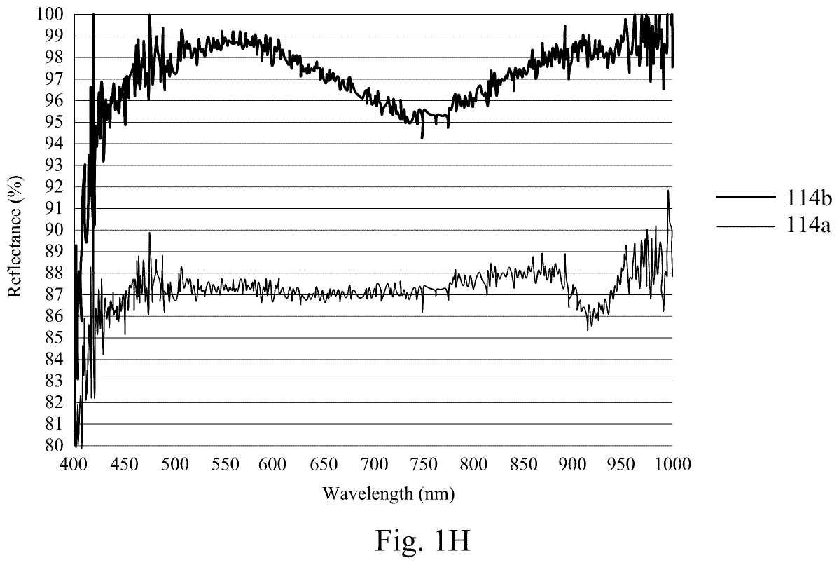

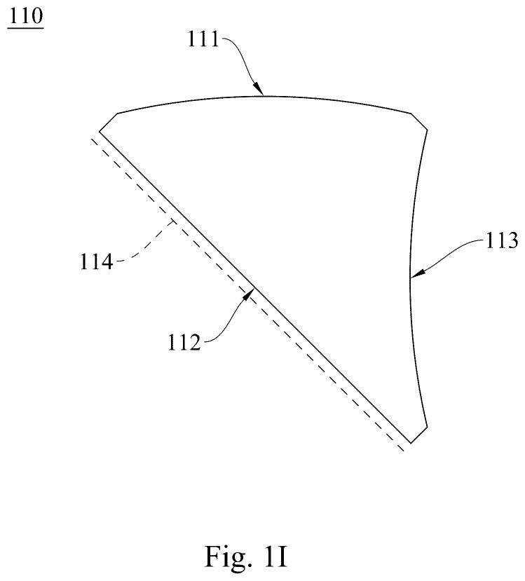

FIG. 1A is a schematic view of an imaging lens module 100 according to the 1st example of the 1st embodiment of the present disclosure. In FIG. 1A, the imaging lens module 100 includes, in order from an object side to an image side, a first lens assembly 101, a plastic optical folding element 110, a second lens assembly 102, a third lens assembly 103, an optical folding element 104 and an image surface 105. The first lens assembly 101 includes a lens barrel element 1011 and at least one lens element 1012, wherein the lens element 1012 is disposed in the lens barrel element 1011 along a first optical axis X1. The second lens assembly 102 includes a lens barrel element 1021 and a plurality of lens elements 1022, wherein the lens elements 1022 are disposed in the lens barrel element 1021 along a second optical axis X2. The third lens assembly 103 includes a lens barrel element 1031 and at least one lens element 1032, wherein the lens element 1032 is disposed in the lens barrel element 1031 along the second optical axis X2. The first optical axis X1 is folded to the second optical axis X2 via the plastic optical folding element 110, and then the second optical axis X2 is folded to a third optical axis X3 via the optical folding element 104 so as to image on the image surface 105. It should be mentioned that the optical folding element 104 can be the same or different with the plastic optical folding element 110, and the following description will mainly illustrate the plastic optical folding element 110.

FIG. 1B is a side view of the plastic optical folding element 110 according to the 1st example of the 1st embodiment of FIG. 1A, FIG. 1C is a three-dimensional view of the plastic optical folding element 110 of FIG. 1B, and FIG. 1D is another three-dimensional view of the plastic optical folding element 110 of FIG. 1B. In FIG. 1A, FIG. 1B, FIG. 1C and FIG. 1D, the plastic optical folding element 110 includes an incident surface 111, a reflection surface 112, an exiting surface 113 and a reflection film 114. A light enters the plastic optical folding element 110 through the incident surface 111, which enters the plastic optical folding element 110 along the first optical axis X1. The reflection surface 112 is for changing a traveling direction of the light, that is, the light is folded via the reflection surface 112, and then travels along the second optical axis X2. The light leaves the plastic optical folding element 110 from the exiting surface 113. The reflection film 114 is disposed on the reflection surface 112. A bottom of the reflection film 114 is physically contacted with the reflection surface 112, a top of the reflection film 114 is disposed relative to the bottom. Further, the plastic optical folding element 110 can further include at least one gate trace 116, which can be located on the surface of the plastic optical folding element 110 which is different from the incident surface 111, the reflection surface 112, and the exiting surface 113.

FIG. 1E is a schematic view of the reflection film 114 of FIG. 1B. In FIG. 1E, the reflection film 114 includes, in order from the bottom to the top which is away from the reflection surface 112, a first multilayer film 1141, a first connecting layer 1142, a first Ag layer 1143, a blocking layer 1144, a second Ag layer 1145, a second connecting layer 1146 and a second multilayer film 1147.

FIG. 1F is a schematic view of the first multilayer film 1141 of FIG. 1E. In FIG. 1E and FIG. 1F, the first multilayer film 1141 includes two first low reflectance layers 1141a and two first high reflectance layers 1141b. A reflectance of each first high reflectance layer 1141b is higher than a reflectance of each first low reflectance layer 1141a, and the first high reflectance layers 1141b and the first low reflectance layers 1141a are stacked alternatively, wherein the first low reflectance layer 1141a is directly stacked on the reflection surface 112. The first connecting layer 1142 is directly stacked on the first high reflectance layer 1141b of the first multilayer film 1141, and the first connecting layer 1142 includes Aluminium oxide. The first Ag layer 1143 is directly stacked on the first connecting layer 1142, and the first Ag layer 1143 includes Argentum. The blocking layer 1144 is directly stacked on the first Ag layer 1143, and the blocking layer 1144 includes Nickel. The second Ag layer 1145 includes Argentum, which is located between the blocking layer 1144 and the second multilayer film 1147.

The second Ag layer 1145 is farther from the reflection surface 112 than the blocking layer 1144 from the reflection surface 112, and is physically contacted with the blocking layer 1144; that is, the second Ag layer 1145 is directly stacked on the blocking layer 1144. The second connecting layer 1146 includes Aluminium oxide, wherein the second connecting layer 1146 is farther from the reflection surface 112 than the second Ag layer 1145 from the reflection surface 112, and is physically contacted with the second Ag layer 1145; that is the second connecting layer 1146 is directly stacked on the second Ag layer 1145. FIG. 1G is a schematic view of the second multilayer film 1147 of FIG. 1E. In FIG. 1E and FIG. 1G, the second multilayer film 1147 includes two second low reflectance layers 1147a and two second high reflectance layers 1147b. A reflectance of each second high reflectance layer 1147b is higher than a reflectance of each second low reflectance layer 1147a, and the second high reflectance layers 1147b and the second low reflectance layers 1147a are stacked alternatively, wherein the second high reflectance layer 1147b is directly stacked on the second connecting layer 1146.

In FIG. 1B, FIG. 1C and FIG. 1D, the plastic optical folding element 110 can further include a plurality of connecting surfaces 115, which are connected to the incident surface 111, the exiting surface 113 and the reflection surface 112. There is a step structure 1151 between the reflection surface 112 and one of the connecting surfaces 115 adjacent thereto for forming a height difference Hs between the reflection surface 112 and the connecting surface 115, wherein, according to the 1st example of the 1st embodiment of FIG. 1B, Hs=0.05 mm.

According to the 1st example of the 1st embodiment, the material and thickness of each layer of the reflection film 114 is stated in the following Table 1A.

TABLE 1A
the 1st example of the 1st embodiment

| Layer No. | | Material | Thickness(nm) |
|---|---|---|---|
| 13 | Second multilayer film 1147 | SiO₂ | 123.26 |
| 12 | | TiO₂ | 28.63 |
| 11 | | SiO₂ | 86.46 |
| 10 | | TiO₂ | 41.7 |
| 9 | Second connecting layer 1146 | Al₂O₃ | 60 |
| 8 | Second Ag layer 1145 | Ag | 70 |
| 7 | Blocking layer 1144 | Ni | 40 |
| 6 | First Ag layer 1143 | Ag | 70 |
| 5 | First connecting layer 1142 | Al₂O₃ | 60 |
| 4 | First multilayer film 1141 | TiO₂ | 35 |
| 3 | | SiO₂ | 80 |
| 2 | | TiO₂ | 20 |
| 1 | | SiO₂ | 70 |

Reflection surface 112

In Table 1A, FIG. 1E, FIG. 1F and FIG. 1G, a layer number of the reflection film 114 and a layer material of the reflection film 114 are symmetrically arranged with the blocking layer 1144 as a center.

According to the 1st example of the 1st embodiment, when a thickness of the first multilayer film 1141 is Dmf1, a thickness of the blocking layer 1144 is Db, a distance between the first Ag layer 1143 and the bottom is Hag1, a distance between the second Ag layer 1145 and the top is Hag2, an average reflectance measured from the bottom of the reflection film 114 reflective to a wavelength from 400 nm to 1000 nm is R1, and an average reflectance measured from the top of the reflection film 114 reflective to a wavelength from 400 nm to 1000 nm is R2, the datum of the parameters are stated in the following Table 1 B.

TABLE 1B
the 1st example of the 1st embodiment

| Dmf1 (nm) | Db (nm) | Hag1 (nm) | Hag2 (nm) | R1 (%) | R2 (%) |
|---|---|---|---|---|---|
| 205 | 40 | 265 | 340.05 | 87.19 | 97.10 |

FIG. 1H shows the reflectance of each of the first side 114a (only labelled in FIG. 1H) and the second side 114b (only labelled in FIG. 1H) of the reflection film 114, wherein the reflectance is measured from the reflection film 114 coated on a plastic plate. The reflectance of the first side 114a is obtained by the light passing through from the bottom of the reflection film 114, and the reflectance of the second side 114b is obtained by the light passing through from the top of the reflection film 114.

FIG. 1I is a three-dimensional view of the plastic optical folding element 110 according to the 2nd example of the 1st embodiment of the present disclosure. In FIG. 1I, the differences between the plastic optical folding element 110 according to the 2nd example of the 1st embodiment and the plastic optical folding element 110 according to the 1st example of the 1st embodiment are, the incident surface 111 and the exiting surface 113 of the plastic optical folding element 110 according to the 2nd example of the 1st embodiment have curvatures. Others elements of the plastic optical folding element 110 according to the 2nd example of the 1st embodiment are the same or similar with the elements of the plastic optical folding element 110 according to the 1st example of the 1st embodiment, which will not be described again herein.

### 2nd Embodiment

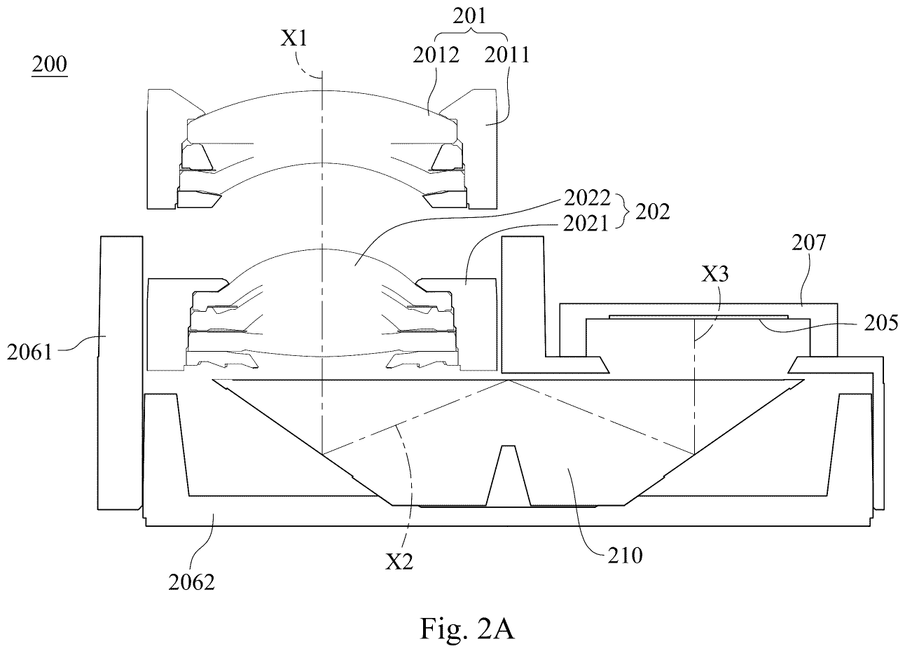

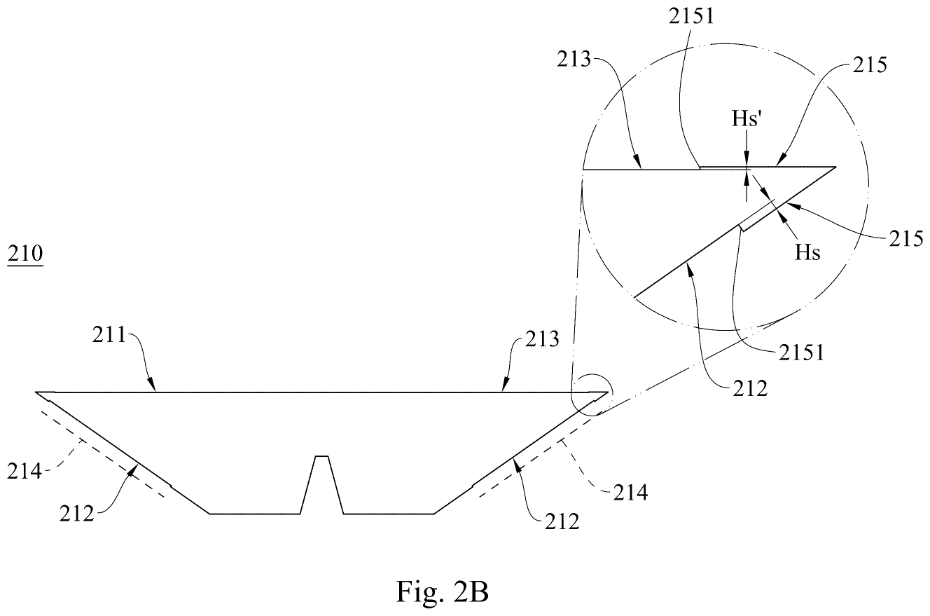

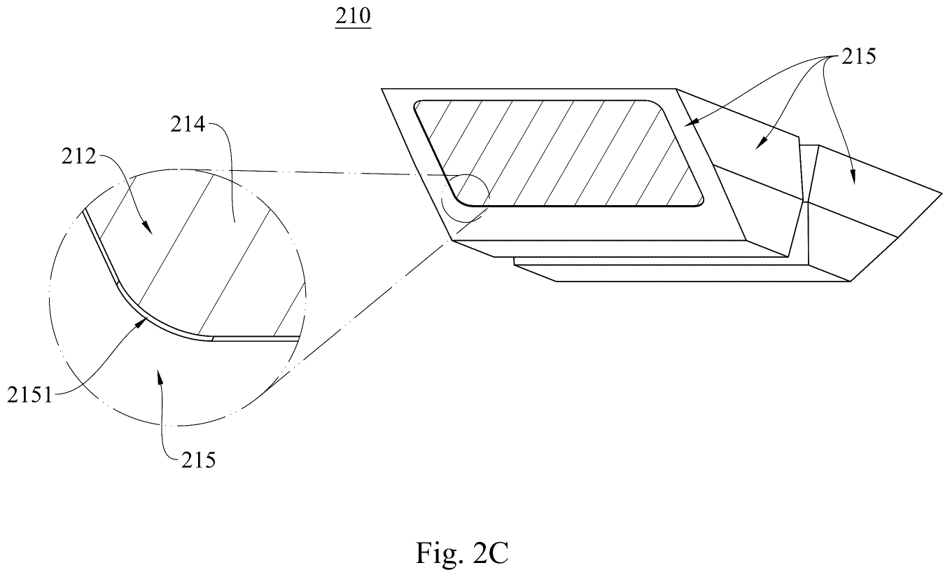

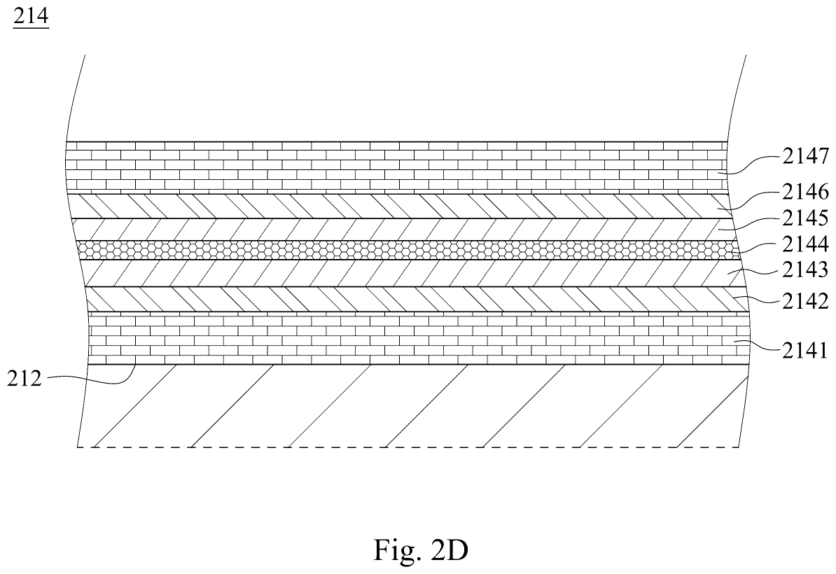

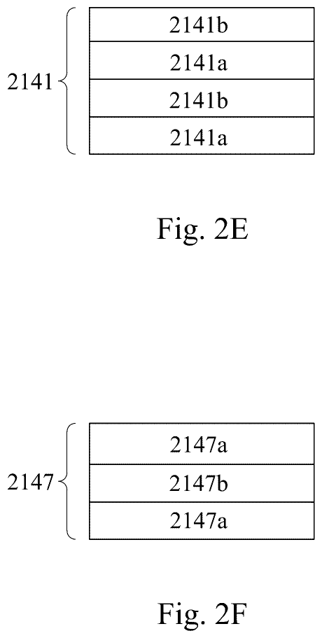

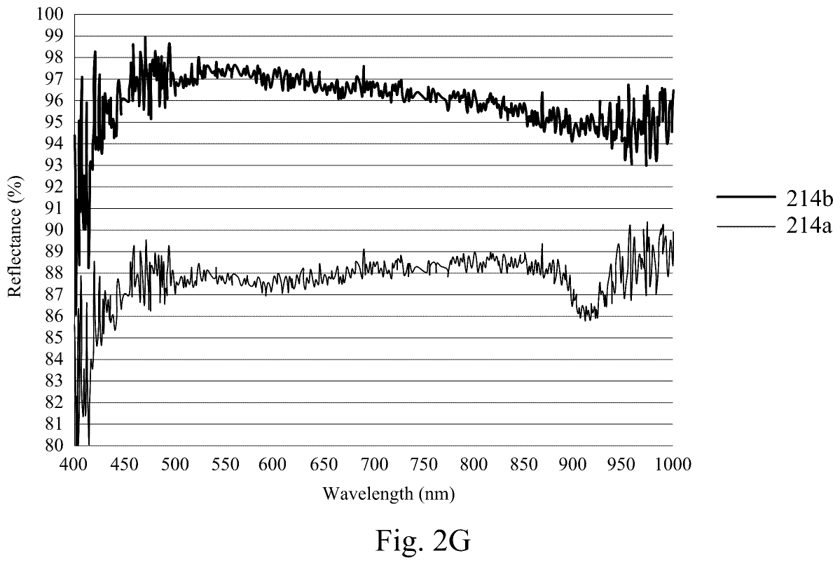

FIG. 2A is a schematic view of an imaging lens module 200 according to the 1st example of the 2nd embodiment of the present disclosure. In FIG. 2A, the imaging lens module 200 includes, in order from an object side to an image side, a first lens assembly 201, a second lens assembly 202, a plastic optical folding element 210 and an image surface 205. The first lens assembly 201 includes a lens barrel element 2011 and a plurality of lens elements 2012, wherein the lens elements 2012 are disposed in the lens barrel element 2011 along a first optical axis X1. The second lens assembly 202 includes a lens barrel element 2021 and a plurality of lens elements 2022, wherein the lens elements 2022 are disposed in the lens barrel element 2021 along the first optical axis X1, and the second lens assembly 202 is disposed on an image side of the first lens assembly 201 along the first optical axis X1. The first optical axis X1 is folded to the second optical axis X2 via the plastic optical folding element 210, and then is folded to a third optical axis X3 so as to image on the image surface 205. Further, the plastic optical folding element 210 is positioned via a cover 2062 and connected to the second lens assembly 202 via a cover 2061. The image surface 205 is disposed on a base 207, and the base is connected to the cover 2061.

FIG. 2B is a side view of the plastic optical folding element 210 according to the 1st example of the 2nd embodiment of FIG. 2A, FIG. 2C is a three-dimensional view of the plastic optical folding element 210 of FIG. 2B. In FIG. 2A, FIG. 2B and FIG. 2C, the plastic optical folding element 210 includes an incident surface 211, two reflection surfaces 212, an exiting surface 213 and two reflection films 214. A light enters the plastic optical folding element 210 through the incident surface 211, which enters the plastic optical folding element 210 along the first optical axis X1. The reflection surfaces 212 are for changing a traveling direction of the light, that is, the light is folded via the reflection surfaces 212, and then travels along the second optical axis X2 and the third optical axis X3. The light leaves the plastic optical folding element 210 from the exiting surface 213. The reflection films 214 are disposed on the reflection surfaces 212. A bottom of each reflection film 214 is physically contacted with each reflection surface 212, a top of each reflection film 214 is disposed relative to the bottom. It should be mentioned that, the incident surface 211 and the exiting surface 213 of the plastic optical folding element 210 is located on the same side thereof, and the plastic optical folding element 210 further includes a total reflection surface (its reference numeral is omitted), so that, the second optical axis X2 is folded via the total reflection surface once before folded to the third optical axis X3 via the reflection surfaces 212.

FIG. 2D is a schematic view of the reflection film 214 of FIG. 2B. In FIG. 2D, the reflection film 214 includes, in order from the bottom to the top which is away from the reflection surface 212, a first multilayer film 2141, a first connecting layer 2142, a first Ag layer 2143, a blocking layer 2144, a second Ag layer 2145, a second connecting layer 2146 and a second multilayer film 2147.

FIG. 2E is a schematic view of the first multilayer film 2141 of FIG. 2D. In FIG. 2D and FIG. 2E, the first multilayer film 2141 includes two first low reflectance layers 2141a and two first high reflectance layers 2141b. A reflectance of each first high reflectance layer 2141b is higher than a reflectance of each first low reflectance layer 2141a, and the first high reflectance layers 2141b and the first low reflectance layers 2141a are stacked alternatively, wherein the first low reflectance layer 2141a is directly stacked on the reflection surface 212. The first connecting layer 2142 is directly stacked on the first high reflectance layer 2141b of the first multilayer film 2141, and the first connecting layer 2142 includes Aluminium oxide. The first Ag layer 2143 is directly stacked on the first connecting layer 2142, and the first Ag layer 2143 includes Argentum. The blocking layer 2144 is directly stacked on the first Ag layer 2143, and the blocking layer 2144 includes Nickel. The second Ag layer 2145 includes Argentum, which is located between the blocking layer 2144 and the second multilayer film 2147. The second Ag layer 2145 is farther from the reflection surface 212 than the blocking layer 2144 from the reflection surface 212, and is physically contacted with the blocking layer 2144; that is, the second Ag layer 2145 is directly stacked on the blocking layer 2144. The second connecting layer 2146 includes Aluminium oxide, wherein the second connecting layer 2146 is farther from the reflection surface 212 than the second Ag layer 2145 from the reflection surface 212, and is physically contacted with the second Ag layer 2145; that is the second connecting layer 2146 is directly stacked on the second Ag layer 2145. FIG. 2F is a schematic view of the second multilayer film 2147 of FIG. 2D. In FIG. 2D and FIG. 2F, the second multilayer film 2147 includes two second low reflectance layers 2147a and one second high reflectance layer 2147b. A reflectance of the second high reflectance layer 2147b is higher than a reflectance of each second low reflectance layer 2147a, and the second high reflectance layer 2147b and the second low reflectance layers 2147a are stacked alternatively, wherein the second low reflectance layer 2147a is directly stacked on the second connecting layer 2146.

In FIG. 2B and FIG. 2C, the plastic optical folding element 210 can further include a plurality of connecting surfaces 215, which are connected to the incident surface 211, the exiting surface 213 and the reflection surfaces 212. There is a step structure 2151 between each reflection surface 212 and one of the connecting surfaces 215 adjacent thereto for forming a height difference Hs between each reflection surface 212 and the connecting surface 215, wherein, according to the 1st example of the 2nd embodiment of FIG. 2B, Hs=0.03 mm. Further, according to the 1st example of the 2nd embodiment of FIG. 2B, the step structure 2151 forms another height difference Hs' between the exiting surface 213 and the connecting surface 215, Hs'=0.01 mm.

According to the 1st example of the 2nd embodiment, the material and thickness of each layer of the reflection film 214 is stated in the following Table 2A.

TABLE 2A
the 1st example of the 2nd embodiment

| Layer No. | | Material | Thickness(nm) |
|---|---|---|---|
| 12 | second multilayer film 2147 | SiO₂ | 20 |
| 11 | | TiO₂ | 44 |
| 10 | | SiO₂ | 26 |
| 9 | second connecting layer 2146 | Al₂O₃ | 28 |
| 8 | second Ag layer 2145 | Ag | 70 |
| 7 | blocking layer 2144 | Ni | 40 |
| 6 | first Ag layer 2143 | Ag | 70 |
| 5 | first connecting layer 2142 | Al₂O₃ | 60 |
| 4 | first multilayer film 2141 | TiO₂ | 35 |
| 3 | | SiO₂ | 80 |
| 2 | | TiO₂ | 20 |
| 1 | | SiO₂ | 70 |

Reflection surface 212

According to the 1st example of the 2nd embodiment, when a thickness of the first multilayer film 2141 is Dmf1, a thickness of the blocking layer 2144 is Db, a distance between the first Ag layer 2143 and the bottom is Hag1, a distance between the second Ag layer 2145 and the top is Hag2, an average reflectance measured from the bottom of the reflection film 214 reflective to a wavelength from 400 nm to 1000 nm is R1, and an average reflectance measured from the top of the reflection film 214 reflective to a wavelength from 400 nm to 1000 nm is R2, the datum of the parameters are stated in the following Table 2B.

TABLE 2B
the 1st example of the 2nd embodiment

| Dmf1 (nm) | Db (nm) | Hag1 (nm) | Hag2 (nm) | R1 (%) | R2 (%) |
|---|---|---|---|---|---|
| 205 | 40 | 265 | 118 | 87.71 | 96.00 |

FIG. 2G shows the reflectance of each of the first side 214a (only labelled in FIG. 2G) and the second side 214b (only labelled in FIG. 2G) of the reflection film 214, wherein the reflectance is measured from the reflection film 214 coated on a plastic plate. The reflectance of the first side 214a is obtained by the light passing through from the bottom of the reflection film 214, and the reflectance of the second side 214b is obtained by the light passing through from the top of the reflection film 214.

### 3rd Embodiment

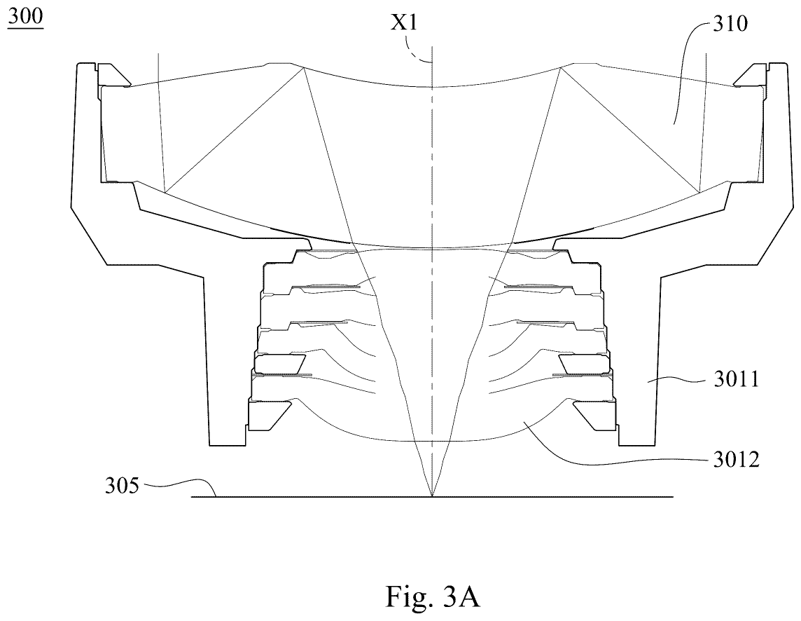

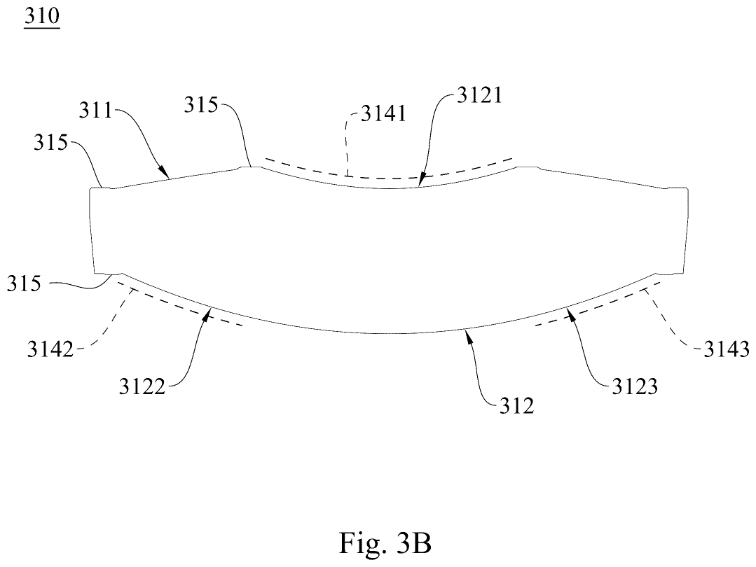

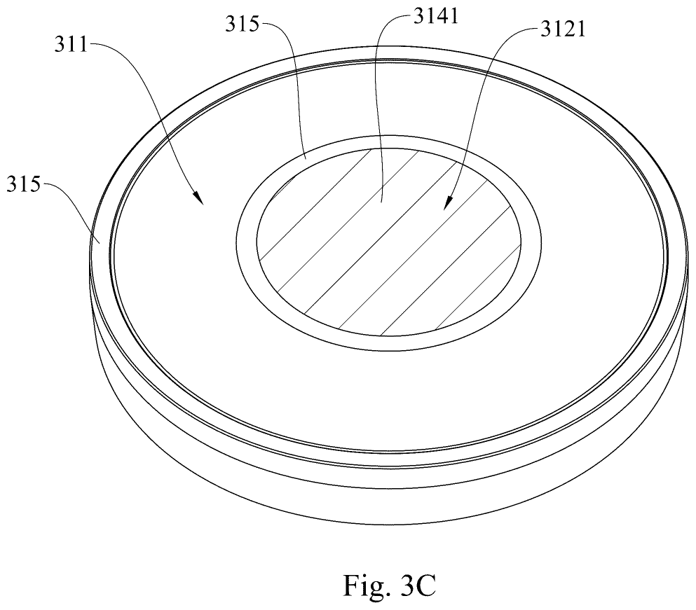

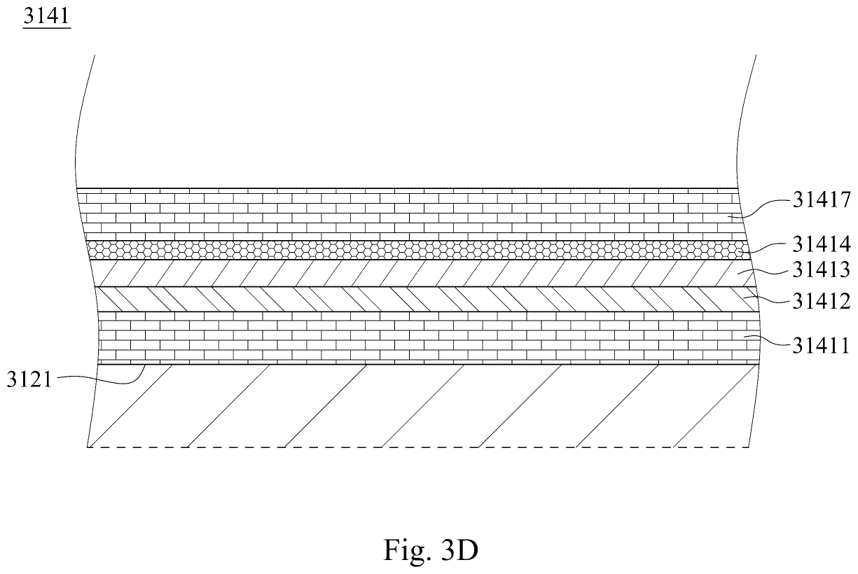

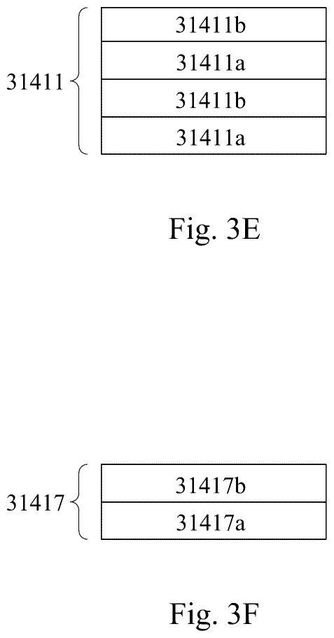

FIG. 3A is a schematic view of an imaging lens module 300 according to the 1st example of the 3rd embodiment of the present disclosure. In FIG. 3A, the imaging lens module 300 includes, in order from an object side to an image side, a plastic optical folding element 310, a plurality of lens elements 3012 and an image surface 305, wherein the plastic optical folding element 310 and the lens elements 3012 are disposed in a lens barrel element 3011 in order from the object side to the image side, and the image surface 305 is disposed on the image side of the plastic optical folding element 310 and the lens elements 3012. The light enters the plastic optical folding element 310 along a first optical axis X1, and is folded by the plastic optical folding element 310 then enters to the lens elements 3012, and then images on the image surface 305.

FIG. 3B is a side view of the plastic optical folding element 310 according to the 1st example of the 3rd embodiment of FIG. 3A, FIG. 3C is a three-dimensional view of the plastic optical folding element 310 of FIG. 3B. In FIG. 3A, FIG. 3B and FIG. 3C, the plastic optical folding element 310 includes an incident surface 311, three reflection surfaces 3121, 3122, 3123, an exiting surface 313 and three reflection films 3141, 3142, 3143, wherein the reflection surface 3121 and the incident surface 311 are on the same side, and the reflection surfaces 3122, 3123 and the exiting surface 313 are on the same side. A light enters the plastic optical folding element 310 through the incident surface 311, which enters the plastic optical folding element 310 along the first optical axis X1. The reflection surfaces 3121, 3122, 3123 are for changing a traveling direction of the light, that is, the light is folded via the reflection surfaces 3121, 3122, 3123. The light leaves the plastic optical folding element 310 from the exiting surface 313, and enters the lens elements 3012. The reflection films 3141, 3142, 3143 are disposed on the reflection surfaces 3121, 3122, 3123, respectively. A bottom of each of the reflection films 3141, 3142, 3143 is physically contacted with each of the reflection surfaces 3121, 3122, 3123, a top of each of the reflection films 3141, 3142, 3143 is disposed relative to the bottom.

FIG. 3D is a schematic view of the reflection film 3141 of FIG. 3B. In FIG. 3D, the reflection film 3141 includes, in order from the bottom to the top which is away from the reflection surface 3121, a first multilayer film 31411, a first connecting layer 31412, a first Ag layer 31413, a blocking layer 31414 and a second multilayer film 31417.

FIG. 3E is a schematic view of the first multilayer film 31411 of FIG. 3D. In FIG. 3D and FIG. 3E, the first multilayer film 31411 includes two first low reflectance layers 31411a and two first high reflectance layers 31411b. A reflectance of each first high reflectance layer 31411b is higher than a reflectance of each first low reflectance layer 31411a, and the first high reflectance layers 31411b and the first low reflectance layers 31411a are stacked alternatively, wherein the first low reflectance layer 31411a is directly stacked on the reflection surface 3121. The first connecting layer 31412 is directly stacked on the first high reflectance layer 31411b of the first multilayer film 31411, and the first connecting layer 31412 includes Aluminium oxide. The first Ag layer 31413 is directly stacked on the first connecting layer 31412, and the first Ag layer 31413 includes Argentum. The blocking layer 31414 is directly stacked on the first Ag layer 31413, and the blocking layer 31414 includes Nickel. FIG. 3F is a schematic view of the second multilayer film 31417 of FIG. 3D. In FIG. 3D and FIG. 3F, the second multilayer film 31417 includes a second low reflectance layer 31417a and a second high reflectance layer 31417b. A reflectance of the second high reflectance layer 31417b is higher than a reflectance of the second low reflectance layer 31417a, and the second high reflectance layer 31417b and the second low reflectance layer 31417a are stacked alternatively, wherein the second low reflectance layer 31417a is directly stacked on the blocking layer 31414.

It should be mentioned that, according to the 1st example of the 3rd embodiment, the structure, material and the relationship with the corresponding reflection surfaces 3122, 3123 of the reflection films 3142, 3143 can be the same with or similar to the aforementioned the reflection film 3141 and the corresponding reflection surface 3121, and will not be described again herein.

In FIG. 3C, the plastic optical folding element 310 can further include a plurality of connecting surfaces 315, which are connected to the incident surface 311 and the reflection surfaces 3122, 3123. There is a step structure (its reference numeral is omitted) between each reflection surface 3122, 3123 and one of the connecting surfaces 315 adjacent thereto for forming a height difference between each reflection surface 3122, 3123 and the connecting surface 315. Further, there is another step structure between the incident surface 311 and one of the connecting surfaces 315 adjacent thereto.

The parameters and material of the elements according to the 1st example of the 3rd embodiment can be the same with or similar to the he elements according to the 1st example of the 1st embodiment or the 2nd embodiment, and will not be described again herein.

### 4th Embodiment

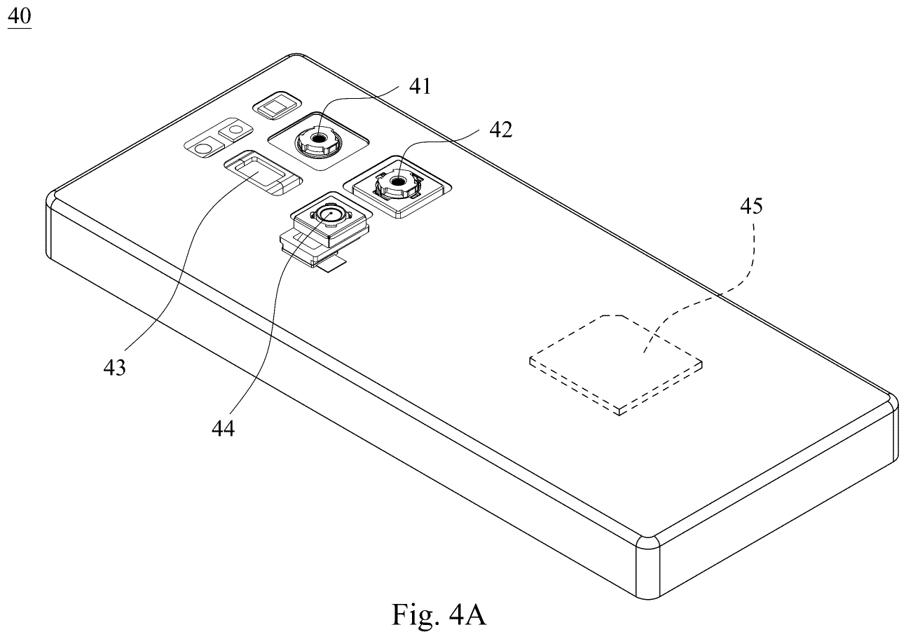

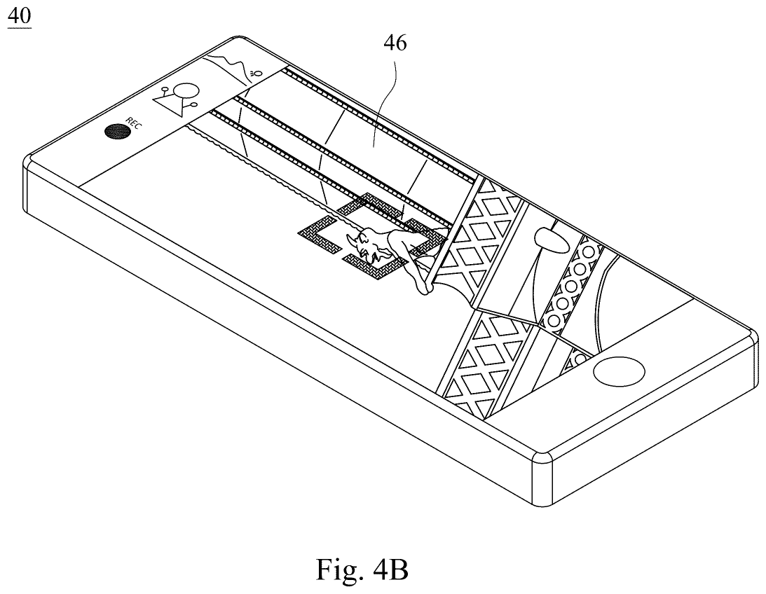

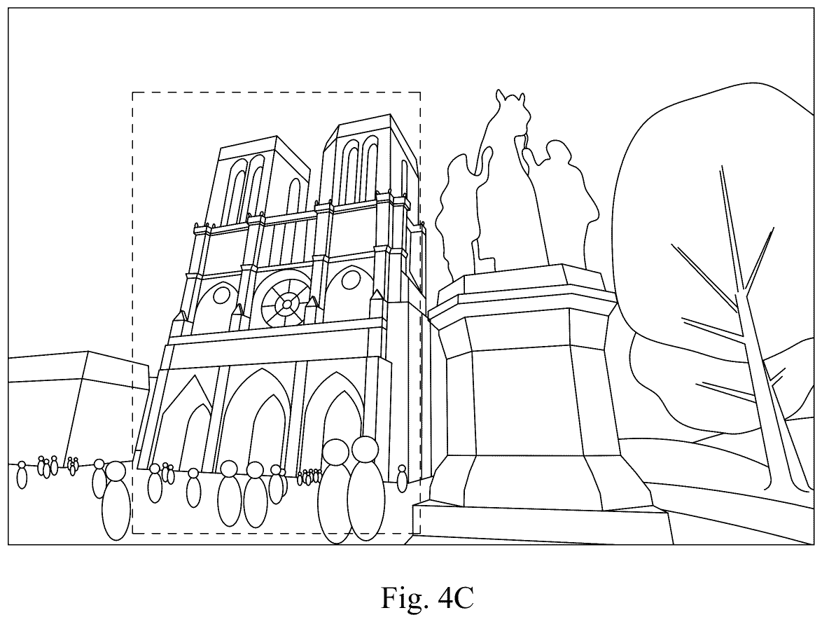

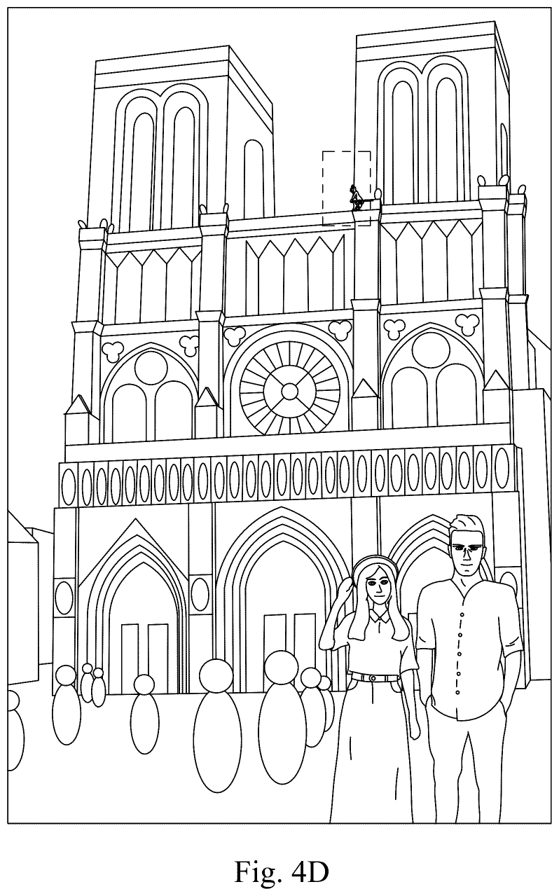

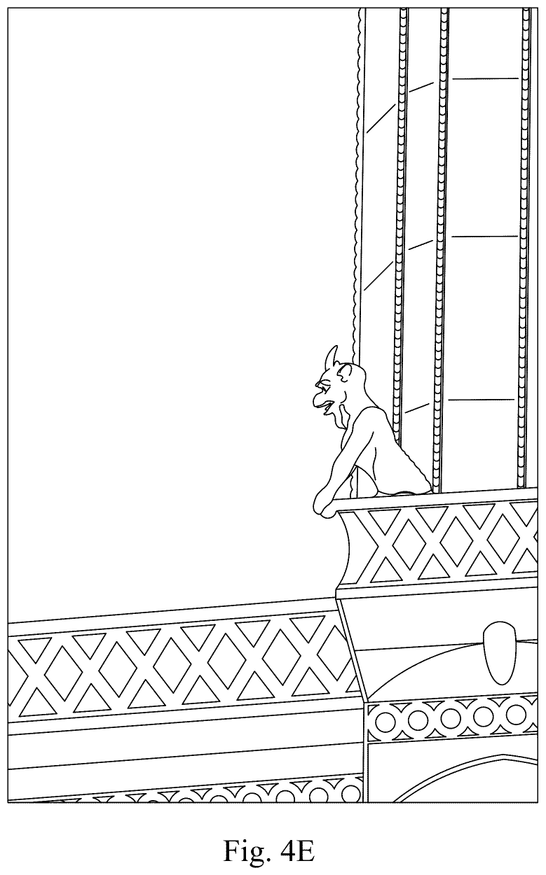

FIG. 4A is a schematic view of an electronic device 40 according to the 4th embodiment of the present disclosure. FIG. 4B is another schematic view of the electronic device 40 according to the 4th embodiment of FIG. 4A. As shown in FIG. 4A and FIG. 4B, the electronic device 40 is a smartphone. The electronic device 40 includes camera modules and a user interface 46, wherein each camera module can includes the imaging lens module according to any example according to the aforementioned 1st to 3rd embodiments. In detail, the camera modules are a high-pixel camera module 41, an ultra-wide-angle camera module 42, and two telephoto camera modules 43, 44, and the user interface 46 is a touch screen, but the present disclosure is not limited thereto.

A user enters a shooting mode via the user interface 46. The user interface 46 is used to display the screen, and the shooting angle can be manually adjusted to switch between different camera modules. At this moment, the camera modules collect an imaging light on the respective image sensor (not shown in figures) and output electronic signals associated with images to an image signal processor (ISP) 45.

As shown in FIG. 4A, according to the camera specifications of the electronic device 40, the electronic device 40 can further include an optical anti-shake mechanism (not shown in figures). Further, the electronic device 40 can further include at least one focusing assisting module (not shown in figures) and at least one sensing component (not shown in figures). The focusing assisting module can be a flash module, an infrared distance measurement component, a laser focus module, etc. The flash module is for compensating the color temperature. The sensing component can have functions for sensing physical momentum and kinetic energies, such as an accelerator, a gyroscope, and a Hall effect element, so as to sense shaking or jitters applied by hands of the user or external environments. Thus the autofocus function and the optical anti-shake mechanism of the imaging lens assembly disposed on the electronic device 40 can function to obtain a great image quality and facilitate the electronic device 40 according to the present disclosure to have a capturing function with multiple modes, such as taking optimized selfies, high dynamic range (HDR) with a low light source, 4K resolution recording, etc. Furthermore, the user can visually see the captured image of the camera through the user interface 46 and manually operate the view finding range on the user interface 46 to achieve the auto focus function of what you see is what you get.

Furthermore, the camera modules, the optical anti-shake mechanism, the sensing component and the focusing assisting module can be disposed on a flexible printed circuit board (FPC) (not shown in figures) and electrically connected to the image signal processor 45 and so on via a connector (not shown in figures) so as to operate a picturing process. Recent electronic devices such as smartphones have a trend towards thinness and lightness. The camera modules and the related elements are disposed on a FPC and circuits are assembled into a main board of an electronic device by a connector. Hence, it can fulfill a mechanical design of a limited inner space of the electronic device and a requirement of a circuit layout and obtain a larger allowance, and it is also favorable for autofocus functions of the camera modules obtaining a flexible control via a touch screen of the electronic device. In the 4th embodiment, the electronic device 40 can include a plurality of the sensing components and a plurality of the focusing assisting modules, and the sensing components and the focusing assisting modules are disposed on an FPC and another at least one FPC (not shown in figures) and electrically connected to the image signal processor 45 and so on via a corresponding connector so as to operate a picturing process. In other embodiments (not shown in figures), the sensing components and auxiliary optical elements can be disposed on a main board of an electronic device or a board of the other form according to a mechanical design and a requirement of a circuit layout.

Furthermore, the electronic device 40 can further include, but not be limited to, a display, a control unit, a storage unit, a random-access memory (RAM), a read-only memory (ROM), or the combination thereof.

FIG. 4C is a schematic view of an image captured via the electronic device 40 according to the 4th embodiment of FIG. 4A. As shown in FIG. 4C, a larger ranged image can be captured via the ultra-wide-angle camera module 42, which has a function for containing more views.

FIG. 4D is another schematic view of the image captured via the electronic device 40 according to the 4th embodiment of FIG. 4A. As shown in FIG. 4D, a certain ranged and high-pixel image can be captured via the high-pixel camera module 41, which has a function for high resolution and low distortion.

FIG. 4E is the other schematic view of the image captured via the electronic device 40 according to the 4th embodiment of FIG. 4A. As shown in FIG. 4E, a far image can be captured and enlarged to a high magnification via the telephoto camera modules 43, 44, which has a function for a high magnification.

As shown in FIG. 4C to FIG. 4E, when an image is captured via different camera modules having various focal lengths and processed via a technology of an image processing, a zoom function of the electronic device 40 can be achieved.

### 5th Embodiment

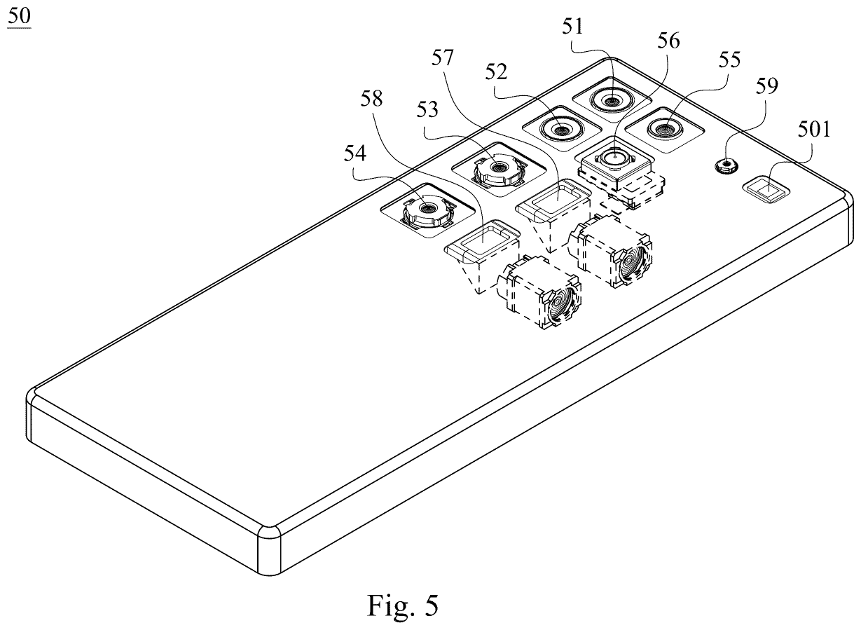

FIG. 5 is a schematic view of an electronic device 50 according to the 5th embodiment of the present disclosure. As shown in FIG. 5, the electronic device 50 is a smartphone. The electronic device 50 includes a plurality of camera modules, wherein each camera module can includes the imaging lens module according to any example according to the aforementioned 1st to 3rd embodiments, but the present disclosure is not limited thereto. In detail, camera modules are two ultra-wide-angle camera modules 51, 52, two wide angle camera modules 53, 54, four telephoto camera modules 55, 56, 57, 58, and a Time-Of-Flight (TOF) module 59, the TOF module 59 can be other types of camera module, which will not be limited to the present arrangement.

Further, the camera modules 57, 58 can have folding function of the light path, but the present disclosure will not be limited thereto.

According to the camera specifications of the electronic device 50, the electronic device 50 can further include an optical anti-shake mechanism (not shown in figures). Further, the electronic device 50 can further include at least one focusing assisting module (not shown in figures) and at least one sensing component (not shown in figures). The focusing assisting module can be a flash module 501, an infrared distance measurement component, a laser focus module, etc. The flash module 501 is for compensating the color temperature. The sensing component can have functions for sensing physical momentum and kinetic energies, such as an accelerator, a gyroscope, and a Hall effect element, so as to sense shaking or jitters applied by hands of the user or external environments. Thus, the autofocus function and the optical anti-shake mechanism of the camera modules disposed on the electronic device 50 can function to obtain a great image quality and facilitate the electronic device 50 according to the present disclosure to have a capturing function with multiple modes, such as taking optimized selfies, high dynamic range (HDR) with a low light source, 4K resolution recording, etc.

Furthermore, all of other structures and dispositions according to the 5th embodiment are the same as the structures and the dispositions according to the 4th embodiment, and will not be described again herein.

The foregoing description, for purpose of explanation, has been described with reference to specific examples. It is to be noted that Tables show different data of the different examples; however, the data of the different examples are obtained from experiments. The examples were chosen and described in order to best explain the principles of the disclosure and its practical applications, to thereby enable others skilled in the art to best utilize the disclosure and various examples with various modifications as are suited to the particular use contemplated. The examples depicted above and the appended drawings are exemplary and are not intended to be exhaustive or to limit the scope of the present disclosure to the precise forms disclosed. Many modifications and variations are possible in view of the above teachings.

What is claimed is:

1. A plastic optical folding element, comprising:
an incident surface, a light entering the plastic optical folding element through the incident surface;
at least one reflection surface, the at least one reflection surface for changing a traveling direction of the light;
an exiting surface, the light leaving the plastic optical folding element from the exiting surface; and
a reflection film disposed on the at least one reflection surface, a bottom of the reflection film physically contacted with the at least one reflection surface, a top of the reflection film disposed relative to the bottom, the reflection film comprising, in order from the bottom to the top which is away from the at least one reflection surface:
a first multilayer film comprising at least one first low reflectance layer and at least one first high reflectance layer, wherein a reflectance of the at least one first high reflectance layer is higher than a reflectance of the at least one first low reflectance layer, and the at least one first high reflectance layer and the at least one first low reflectance layer are stacked alternatively;
a first connecting layer comprising Aluminium oxide;
a first Ag layer comprising Argentum;
a blocking layer comprising at least one of Nickel, Titanium, Vanadium, Chromium, Nickel oxide, Titanium oxide, Vanadium oxide and Chromium oxide; and
a second multilayer film comprising at least one second low reflectance layer and at least one second high reflectance layer, wherein a reflectance of the at least one second high reflectance layer is higher than a reflectance of the at least one second low reflectance layer, and the at least one second high reflectance layer and the at least one second low reflectance layer are stacked alternatively;
wherein a thickness of the first multilayer film is Dmf1, a thickness of the blocking layer is Db, a distance between the first Ag layer and the bottom is Hag1, and the following conditions are satisfied:
$$70 nm < Dmf 1 < 420 nm ;$$
$$20 nm < Db < 180 nm ; and$$
$$90 nm < Hag 1 < 550 nm .$$

2. The plastic optical folding element of claim 1, wherein the reflection film further comprises:
a second Ag layer comprising Argentum, and located between the blocking layer and the second multilayer film, wherein the second Ag layer is farther from the at least one reflection surface than the blocking layer from the at least one reflection surface, and is physically contacted with the blocking layer; and
a second connecting layer comprising Aluminium oxide, wherein the second connecting layer is farther from the at least one reflection surface than the second Ag layer from the at least one reflection surface, and is physically contacted with the second Ag layer.

3. The plastic optical folding element of claim 2, wherein a layer number of the reflection film and a layer material of the reflection film are symmetrically arranged with the blocking layer as a center.

4. The plastic optical folding element of claim 2, wherein at least one of the incident surface, the exiting surface and the at least one reflection surface has a curvature.

5. The plastic optical folding element of claim 2, wherein a number of the at least one reflection surface is at least two.

6. The plastic optical folding element of claim 2, wherein a distance between the second Ag layer and the top is Hag2, and the following condition is satisfied:
$$60 nm < Hag 2 < 480 nm .$$

7. The plastic optical folding element of claim 1, wherein the distance between the first Ag layer and the bottom is Hag1, and the following condition is satisfied:
$$180 nm < Hag 1 < 460 nm .$$

8. The plastic optical folding element of claim 1, wherein the thickness of the blocking layer is Db, and the following condition is satisfied:
$$35 nm < D b < 120 nm .$$

9. The plastic optical folding element of claim 1, wherein an average reflectance measured from the bottom of the reflection film reflective to a wavelength from 400 nm to 1000 nm is R1, and the following condition is satisfied:
$$85 \% < R 1 < 100 \% .$$

10. The plastic optical folding element of claim 1, wherein an average reflectance measured from the top of the reflection film reflective to a wavelength from 400 nm to 1000 nm is R2, and the following condition is satisfied:
$$95 \% < R 2 < 100 \% .$$

11. The plastic optical folding element of claim 1, wherein a main material of the blocking layer is Nickel.

12. The plastic optical folding element of claim 1, further comprising:
a plurality of connecting surfaces connected to the incident surface, the exiting surface and the at least one reflection surface, wherein there is a step structure between the at least one reflection surface and one of the connecting surfaces adjacent thereto for forming a height difference between the at least one reflection surface and the connecting surface, the height difference is Hs, and the following condition is satisfied:
$$0.005 mm \leq Hs \leq 0.22 mm .$$

13. A plastic optical folding element, comprising:
an incident surface, a light entering the plastic optical folding element through the incident surface;
at least one reflection surface, the at least one reflection surface for changing a traveling direction of the light;
an exiting surface, the light leaving the plastic optical folding element from the exiting surface; and
a reflection film disposed on the at least one reflection surface, a bottom of the reflection film physically contacted with the at least one reflection surface, a top of the reflection film disposed relative to the bottom, the reflection film comprising, in order from the bottom to the top which is away from the at least one reflection surface:
a first multilayer film comprising at least one first low reflectance layer and at least one first high reflectance layer, wherein a reflectance of the at least one first high reflectance layer is higher than a reflectance of the at least one first low reflectance layer, and the at least one first high reflectance layer and the at least one first low reflectance layer are stacked alternatively;
a first connecting layer comprising Aluminium oxide;
a first Ag layer comprising Argentum; and
a blocking layer comprising at least one of Nickel, Titanium, Vanadium, Chromium, Nickel oxide, Titanium oxide, Vanadium oxide and Chromium oxide;
wherein a thickness of the first multilayer film is Dmf1, a thickness of the blocking layer is Db, a distance between the first Ag layer and the bottom is Hag1, and the following conditions are satisfied:
$$0.1 < Db / Dmf 1 < 0.9 ;$$
$$70 nm < Dmf 1 < 420 nm ; and$$
$$90 nm < Hag 1 < 550 nm .$$

14. The plastic optical folding element of claim 13, wherein the reflection film further comprises:
a second Ag layer comprising Argentum, wherein the second Ag layer is farther from the at least one reflection surface than the blocking layer from the at least one reflection surface, and is physically contacted with the blocking layer.

15. The plastic optical folding element of claim 14, wherein at least one of the incident surface, the exiting surface and the at least one reflection surface has a curvature.

16. The plastic optical folding element of claim 14, wherein a number of the at least one reflection surface is at least two.

17. The plastic optical folding element of claim 13, wherein the distance between the first Ag layer and the bottom is Hag1, and the following condition is satisfied:
$$180 nm < Hag 1 < 460 nm .$$

18. The plastic optical folding element of claim 13, wherein the thickness of the blocking layer is Db, and the following condition is satisfied:
$$35 nm < Db < 120 nm .$$

19. The plastic optical folding element of claim 18, wherein the thickness of the first multilayer film is Dmf1, the thickness of the blocking layer is Db, and the following condition is satisfied:
$$0.1 < Db / Dmf 1 < 0.4 .$$

20. The plastic optical folding element of claim 13, wherein an average reflectance measured from the bottom of the reflection film reflective to a wavelength from 400 nm to 1000 nm is R1, and the following condition is satisfied:
$$85 \% < R 1 < 100 \% .$$

21. The plastic optical folding element of claim 14, wherein an average reflectance measured from the top of the reflection film reflective to a wavelength from 400 nm to 1000 nm is R2, and the following condition is satisfied:
$$95 \% < R 2 < 100 \% .$$

22. The plastic optical folding element of claim 13, wherein a main material of the blocking layer is Nickel.

23. The plastic optical folding element of claim 13, further comprising:
a plurality of connecting surfaces connected to the incident surface, the exiting surface and the at least one reflection surface, wherein there is a step structure between the at least one reflection surface and one of the connecting surfaces adjacent thereto for forming a height difference between the at least one reflection surface and the connecting surface, the height difference is Hs, and the following condition is satisfied:
$$0.005 mm \leq Hs \leq 0.22 mm .$$

24. An imaging lens module, comprising:
the plastic optical folding element of claim 1.

25. An imaging lens module, comprising:
the plastic optical folding element of claim 13.

26. An electronic device, comprising:
the imaging lens module of claim 24.

27. An electronic device, comprising:
the imaging lens module of claim 25.
